(19) United States
(12) Patent Application Publication
(10) Pub. No.: US 2008/0211777 A1
(43) Pub. Date: Sep. 4, 2008

(54) Stroke number input

(75) Inventors: Dong Li, Beijing (CN); Qian Xun Johnson Li, Beijing (CN)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/713,256

(22) Filed: Mar. 1, 2007

(51) Int. Cl. G09G 5/00; G06F 3/02; G06F 17/20; G06F 17/00

(52) U.S. Cl. 345/171; 345/156; 715/264; 715/268; 704/8

(57) ABSTRACT

Stroke number input may be provided. A first integer corresponding to a number of stokes in a logogram or corresponding to a radical associated with the logogram may be received. If the first integer corresponds to the radical, a second integer corresponding to the number of stokes in the logogram other than the radical may be received. Next, if the first integer corresponds to the number of stokes, a plurality of logograms may be displayed each having a number of strokes equal to the received first integer. If, however, the first integer corresponds to the radical associated with a logogram, the plurality of logograms may be displayed each having a radical corresponding to the received first integer and a number of strokes, other than the radical, equal to the received second integer. Then, a selection of a one of the plurality of logograms may be received.

### RELATED APPLICATIONS

Related U.S. patent application Ser. No. ______, filed on even date herewith in the name of and entitled “Integrated Pinyin and Stroke Input,” assigned to the assignee of the present application and related U.S. patent application Ser. No. ______, filed on even date herewith in the name of ______ and entitled “Shared Language Model,” assigned to the assignee of the present application are both hereby incorporated by reference.

### BACKGROUND

A Chinese character is a logogram used in writing Chinese. A complete writing system in Chinese characters appeared in China 3200 years ago during the Shang dynasty, making it what is believed to be the oldest “surviving” writing system. Because the logograms used in writing Chinese are predominantly pictographs, the linkages to the modern Chinese writing system may be decipherable be linguistic archaeologists. Consequently, because thousands of different logograms are used in Chinese, it is difficult to enter Chinese using a computer keyboard.

Once way to represent Chinese characters is to use a “Pinyin” (where “pin” means “spell” and “yin” means “sound”). Pinyin is a way to represent Chinese characters and express the sounds in the Chinese language using the Roman alphabet. There are other systems to express Mandarin Chinese, but pinyin is the most accepted and widely used. Once learned, a person who has learned pinyin will know how to pronounce any word in Mandarin using a Chinese dictionary. Pinyin is also the most common way to input Chinese characters into a computer. Although pinyin and English both use the Roman alphabet, many letters are not expressed with the same sounds that English uses.

Furthermore, words expressed in pinyin use a set of 21 sounds representing the beginning of the word called initials, and a set of 37 sounds representing the end of the word called finals. These combine to form about 420 different sounds. For example, the word for “Flower” expressed in pinyin is “huā”. In this word, the letter “h” is the initial and “uā” is the final. In addition, words are often combined to form compound words. For example, the word for “China” expressed in pinyin is “zhōngguó”. Zhōng means middle (initial: “zh”, final: “ōng”) and guó means country (initial: “g”, final: “uó”).

Moreover, words in Mandarin that have the same pronunciation can have different meanings depending on how the word is said. The “tone” of a word in Chinese describes how the pitch of the speaker's voice changes as the word is said. There are four “tones” in Mandarin. The tones are represented in pinyin by marks above the words.

On a conventional computer with a QWERTY keyboard, there may only be phonetic or pinyin input processes for Chinese input. With convention pinyin processes, however, input users have no way to input Chinese characters if they don't know the pinyin or if there is no pinyin assigned to a specific Chinese character.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Stroke number input may be provided. A first integer corresponding to a number of stokes in a logogram or corresponding to a radical associated with the logogram may be received. If the first integer corresponds to the radical, a second integer corresponding to the number of stokes in the logogram other than the radical may be received. Next, if the first integer corresponds to the number of stokes, a plurality of logograms may be displayed each having a number of strokes equal to the received first integer. If, however, the first integer corresponds to the radical associated with a logogram, the plurality of logograms may be displayed each having a radical corresponding to the received first integer and a number of strokes, other than the radical, equal to the received second integer. Then, a selection of a one of the plurality of logograms may be received.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing stroke number input;

FIG. 3 is a flow chart of another method for providing stroke number input; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Stroke number input may be provided. Conventional systems using a desktop or laptop computer with a QWERTY keyboard support only phonetic or pinyin input processes, for example, for Chinese. One problem with a conventional pinyin input process is that users may have no way to input Chinese characters if the users do not know the pinyin for a desired Chinese character or if there is no pinyin assigned to the desired Chinese character. Consistent with embodiments of the invention, stroke-based input processes (e.g. stroke order and stroke number input processes) may solve this pinyin input process problem. For example, logograms (e.g. Chinese characters) may comprise a radical part and remaining strokes. The radical part comprises strokes as well. As described in more detail below, with stroke-based input processes, users may input, for example, Chinese characters without knowing the characters pronunciations. Furthermore, using a language model (LM), embodiments of the invention may provide users with higher conversion accuracy.

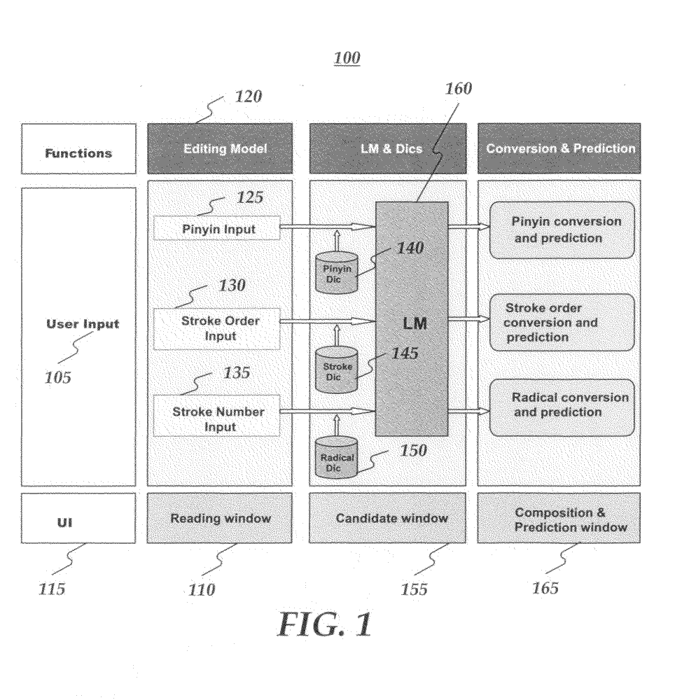

Consistent with embodiments of the present invention, FIG. 1 illustrates an exemplary operating environment for an integrated pinyin and stroke input system 100. User input 105 may be entered by a user into a reading window 110 of a user interface 115. User input 105 may indicate which editing model 120 the user wishes to invoke and data corresponding to a logogram (e.g. Chinese character). For example, the user may provide input 105 indicating a desire to use a pinyin input model 125, a stroke order input model 130, or a stroke number input model 135. The data corresponding to the logogram may be sent to the desired editing model 120 that in turn may use a dictionary (e.g. a pinyin dictionary 140, a stroke dictionary 145, or a radical dictionary 150). The desired editing model 120 may use the data corresponding to the logogram to produce a plurality of logogram candidates in a candidate window 155 associated with user interface 115. Furthermore, a LM 160 may be used to provide the user with higher conversion accuracy. For example, LM 160 may be used to predict a logogram by use frequency or based on a preceding logogram. LM 160 may be shared between pinyin input model 125, stroke order input model 130, and stroke number input model 135. The plurality of logogram candidates may be improved by LM 160 and placed in a composition and prediction window 165.

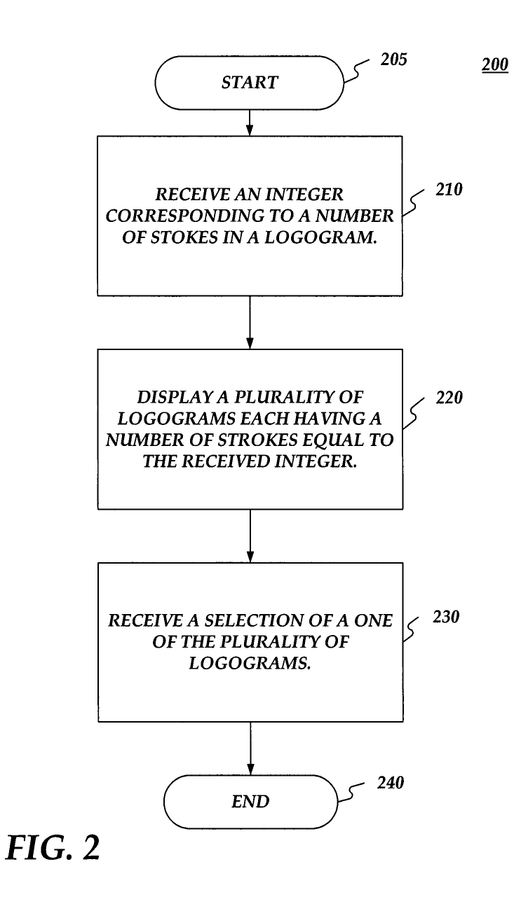

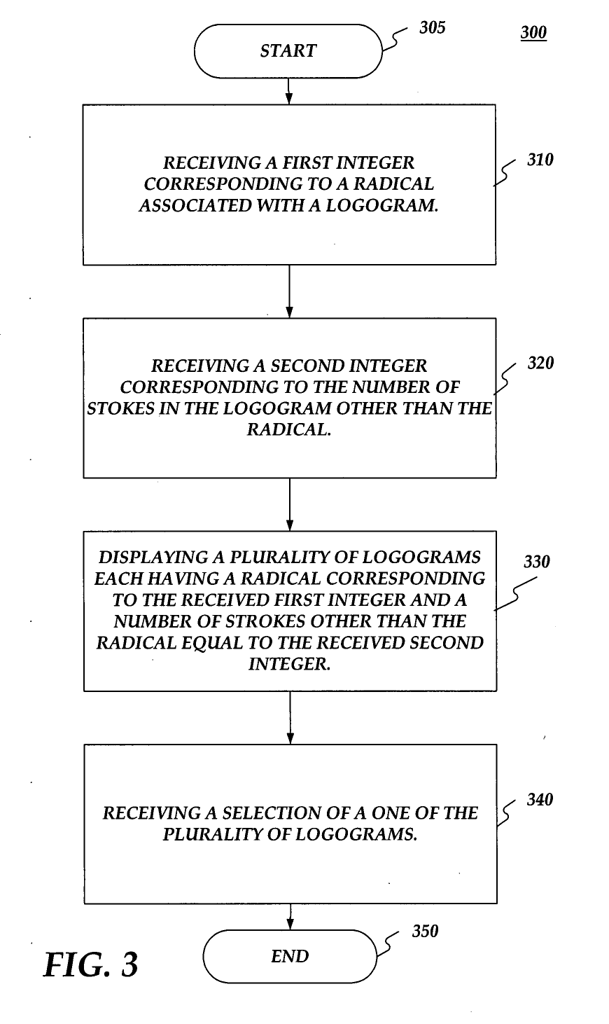

For example, each Chinese character may comprise a radical part and remaining strokes. The radical part may comprise strokes as well. Consistent with embodiments of the invention, stroke number input may be based on a dictionary lookup. Chinese characters may be looked-up in a dictionary based on the radical part first, and then based on the remaining strokes other than the radical. Consequently, Chinese characters may be input in the stroke number input mode in at least two ways: i) total stroke number input (may produce a longer candidate list); and ii) radical and stroke number input (may produce a shorter candidate list). Total stroke number input is discussed in greater detail below with respect to FIG. 2. Radical and stroke number input is discussed in greater detail below with respect to FIG. 3. While embodiments of the invention are described in the context of Chinese characters, any logogram based language may be used and the invention in not limited to Chinese.

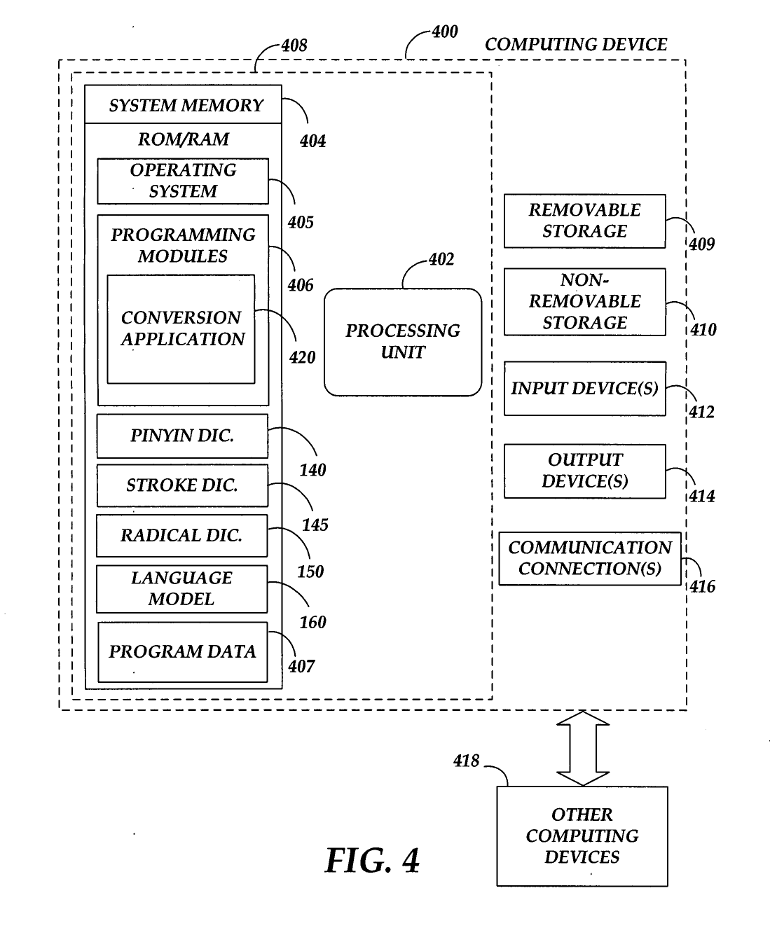

FIG. 2 is a flow chart setting forth the general stages involved in a method 200 consistent with an embodiment of the invention for providing stroke number input. Method 200 may be implemented using a computing device 400 as described in more detail below with respect to FIG. 4. Ways to implement the stages of method 200 will be described in greater detail below. Method 200 may begin at starting block 205 and proceed to stage 210 where computing device 400 may receive an integer corresponding to a number of stokes in a logogram. For example, a user may enter input into computing device 400 using a keyboard. The input may include a key sequence corresponding, for example, to a stroke number input mode. Moreover, the first input may be received in response to the user selecting an item from a menu with a mouse. Items in the menu may correspond at least to the stroke number input mode. As described above, embodiments of the invention may support both a leading key via keyboard input process, a menu item selection via mouse input process, or any other type input process. In addition, the first input may include data corresponding to a logogram the user wishes to enter into computing device 400. The data may include the integer corresponding to the number of stokes in the logogram the user wishes to enter into computing device 400.

From stage 210, where computing device 400 receives the integer corresponding to the number of stokes in the logogram, method 200 may advance to stage 220 where computing device 400 may display a plurality of logograms each having a number of strokes equal to the received integer. For example, with the total stroke number input, the total stroke number of a Chinese character may be counted by the user. Then, the user may input the stroke number in device 400 as the integer as described above with respect to stage 210. Device 400 may receive the integer corresponding to the total stroke number of the Chinese character the user wishes to enter into device 400. Device 400 may then perform a dictionary look-up to find all logograms in the dictionary having a number of strokes equal to the received integer. Device 400 may perform this dictionary look-up on, for example, pinyin dictionary 140, stroke dictionary 145, radical dictionary 150, or language model 160. The aforementioned are examples and any dictionary may be used. The logograms, produced by the dictionary look-up, having the number of strokes equal to the received integer may be displayed to the user in a candidate window. For example, the user may wish to enter [symbol] into device 400. The user make count [symbol] as having a total stroke number of 7. As a result, the user may input 7 in device 400. Accordingly, device 400 may display a candidate window of Chinese characters each having 7 strokes.

Once computing device 400 displays the plurality of logograms (e.g. Chinese characters) in stage 220, method 200 may continue to stage 230 where computing device 400 may receive a selection of a one of the plurality of logograms. For example, once device 400 displays the candidate window of Chinese characters as described above with respect to stage 220, the user may select one of the plurality of Chinese characters from the candidate window. After computing device 400 receives the selection in stage 230, method 200 may then end at stage 240.

FIG. 3 is a flow chart setting forth the general stages involved in a method 300 consistent with another embodiment of the invention for providing stroke number input. Method 300 may be implemented using a computing device 400 as described in more detail below with respect to FIG. 4. Ways to implement the stages of method 300 will be described in greater detail below. Method 300 may begin at starting block 305 and proceed to stage 310 where computing device 400 may receive a first integer corresponding to a radical associated with a logogram. For example, a user may enter input into computing device 400 using a keyboard. The input may include a key sequence corresponding, for example, to a stroke number input mode. In addition, the first input may include data corresponding to a logogram the user wishes to enter into computing device 400. The data may include the first integer corresponding to a radical associated with the logogram the user wishes to enter into computing device 400. As stated above, each Chinese character may comprise a radical part and remaining strokes. For example 20 different radicals can respectively be coded as radicals 1 through 20. The user may view the logogram the user wishes to enter into computing device 400 to determine which code the logogram's radical corresponds to. This determined code may be entered into device 400 as the first integer.

From stage 310, where computing device 400 receives the first integer, method 300 may advance to stage 320 where computing device 400 may receive a second integer corresponding to the number of stokes in the logogram other than the radical. For example, the user may view the logogram the user wishes to enter into computing device 400 to determine the number of strokes in the logogram excluding the logogram's radical. This determined stroke count may be entered into device 400 as the second integer.

Once computing device 400 receives the second integer in stage 320, method 300 may continue to stage 330 where computing device 400 may display a plurality of logograms. Each of the displayed plurality of logograms may have a radical corresponding to the received first integer and a number of strokes other than the radical equal to the received second integer. For example, with the radical and stroke number input, the user may count and input a number corresponding to the radical part to find the right radical from a radical candidate list. Then the user may count and input the number of remaining strokes (excluding the radical) and select the desired Chinese character from a candidate list. For example, “ [symbol] ”, may have a radical of “ [symbol] ”. In addition, the remaining strokes are [symbol] and “ [symbol] ” (e.g. [symbol] and [symbol] . The number for radical “ [symbol] ” may be 3 and the remaining strokes may be 4.

After computing device 400 displays the plurality of logograms in stage 330, method 300 may proceed to stage 340 where computing device 400 may receive a selection of a one of the plurality of logograms. For example, as described above with respect to stage 330, the user may input 3 into device 400 to find the radical “ [symbol] ” from a radical candidate list. The user may then continue to input the remaining stroke number 4 into device 400. In response, device 400 may provide the user a candidate window with a plurality of logograms corresponding the entered input. Consequently, the user may then select the desired Chinese character from the displayed candidate window. Once computing device 400 receives the selection in stage 340, method 300 may then end at stage 350.

An embodiment consistent with the invention may comprise a system for providing conversion. The system may comprise a memory storage and a processing unit coupled to the memory storage. The processing unit may be operative to receive data based on a stroke number input mode. In addition, the processing unit may be operative to convert the received data based upon the stroke number input mode and to display the converted received data.

Another embodiment consistent with the invention may comprise a system for providing conversion. The system may comprise a memory storage and a processing unit coupled to the memory storage. The processing unit may be operative to receive an integer corresponding to a number of stokes in a logogram. The procession unit may be further operative to display a plurality of logograms each having a number of strokes equal to the received integer and to receive a selection of a one of the plurality of logograms.

Yet another embodiment consistent with the invention may comprise a system for providing conversion. The system may comprise a memory storage and a processing unit coupled to the memory storage. The processing unit may be operative to receive a first integer corresponding to a radical associated with a logogram and to receive a second integer corresponding to the number of stokes in the logogram other than the radical. In addition, the processing unit may be operative to display a plurality of logograms each having a radical corresponding to the received first integer and a number of strokes other than the radical equal to the received second integer. Furthermore, the processing unit may be operative to receive a selection of a one of the plurality of logograms.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise an operating environment for system 100 as described above with respect to FIG. 1. System 100 may operate in other environments and is not limited to computing device 400.

With reference to FIG. 4, a system consistent with an embodiment of the invention may-include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include pinyin dictionary 140, stroke dictionary 145, radical dictionary 150, language model 160, and a program data 407. Operating system 405, for example, may be suitable for controlling computing device 400's operation. In one embodiment, programming modules 406 may include, for example a conversion application 420. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. conversion application 420) may perform processes including, for example, one or more method 200's or method 300's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared; or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the-property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing conversion, the method comprising:
receiving data based on a stroke number input mode;
converting the received data based upon the stroke number input mode; and
displaying the converted received data.

2. The method of claim 1, further comprising receiving an input comprising a user initiated keyboard sequence configured to initiate the stroke number input mode prior to receiving the data.

3. The method of claim 1, wherein receiving the data based on the stroke number input mode comprises receiving the data comprising an integer corresponding to a number of stokes in a logogram.

4. The method of claim 1, wherein receiving the data based on the stroke number input mode comprises receiving the data comprising an integer corresponding to a number of stokes in a logogram comprising a Chinese character.

5. The method of claim 1, wherein receiving the data based on the stroke number input mode comprises receiving the data comprising a first integer corresponding to a radical associated with a logogram and a second integer corresponding to a number of stokes in the logogram other than the radical.

6. The method of claim 1, wherein receiving the data based on the stroke number input mode comprises receiving the data comprising a first integer corresponding to a radical associated with a logogram and a second integer corresponding to a number of stokes in the logogram other than the radical, the logogram comprising a Chinese character.

7. The method of claim 1, wherein receiving the data based on the stroke number input mode comprises receiving the data comprising a first integer corresponding to a radical associated with a logogram and a second integer corresponding to a number of stokes in the logogram other than the radical, the logogram having stokes comprising at least two of the following: [symbol] and “ [symbol] ”.

8. The method of claim 1, wherein converting the received data based upon the stroke number input mode comprises creating a logogram based upon the received data, the converted received data comprising the logogram.

9. The method of claim 1, wherein converting the received data comprises:
displaying a plurality of logograms each having a number of strokes equal to a received integer in the data; and
receiving a selection of a one of the plurality of logograms.

10. The method of claim 9, wherein displaying the plurality of logograms comprises displaying the plurality of logograms each having stokes selected from the following: [symbol] and “ [symbol] ”.

11. The method of claim 1, wherein converting the received data comprises:
displaying a plurality of logograms each having a radical corresponding to a received first integer in the data and a number of strokes other than the radical equal to a received second integer in the data; and
receiving a selection of a one of the plurality of logograms.

12. The method of claim 11, wherein displaying the plurality of logograms comprises displaying the plurality of logograms each having stokes selected from the following: [symbol] and “ [symbol] ”.

13. A system for providing conversion, the system comprising:
a memory storage; and
a processing unit coupled to the memory storage, wherein the processing unit is operative to:
receive an integer corresponding to a number of stokes in a logogram;
display a plurality of logograms each having a number of strokes equal to the received integer; and
receive a selection of a one of the plurality of logograms.

14. The system of claim 13, wherein the processing unit is further operative to receive an input comprising a user initiated keyboard sequence configured to initiate a stroke number input mode prior to the processing unit receiving the integer.

15. The system of claim 13, wherein the processing unit being operative to receive the integer corresponding to the number of stokes in the logogram comprises the processing unit being operative to receive the integer corresponding to the number of stokes in the logogram comprising a Chinese character.

16. The system of claim 13, wherein the processing unit being operative to receive the integer corresponding to the number of stokes in the logogram comprises the processing unit being operative to receive the integer corresponding to the number of stokes in the logogram having stokes comprising at least two of the following: [symbol] and “ [symbol] ”.

17. A computer-readable medium which stores a set of instructions which when executed performs a method for providing conversion, the method executed by the set of instructions comprising:
receiving a first integer corresponding to a radical associated with a logogram;
receiving a second integer corresponding to the number of stokes in the logogram other than the radical;
displaying a plurality of logograms each having a radical corresponding to the received first integer and a number of strokes other than the radical equal to the received second integer; and
receiving a selection of a one of the plurality of logograms.

18. The computer-readable medium of claim 17, further comprising receiving an input comprising a user initiated keyboard sequence configured to initiate a stroke number input mode prior to the processing unit receiving the first integer and the second integer.

19. The computer-readable medium of claim 17, wherein receiving the first integer corresponding to the radical associated with the logogram comprises receiving the first integer corresponding to the radical associated with the logogram comprising a Chinese character.

20. The computer-readable medium of claim 17 wherein receiving the first integer corresponding to the radical associated with the logogram comprises receiving the first integer corresponding to the radical associated with the logogram having stokes comprising at least two of the following: [symbol] and “ [symbol] ”.
